(19) United States
(12) Patent Application Publication
(10) Pub. No.: US 2011/0061313 A1
(43) Pub. Date: Mar. 17, 2011

(54) ADAPTERS FOR THE BOOM ARM OF AN AERIAL WORK PLATFORM

(76) Inventor: Donald VOS, Shadow Hills, CA (US)

(21) Appl. No.: 12/560,687

(22) Filed: Sep. 16, 2009

(51) Int. Cl. F16M 13/02; B66F 11/04; B66F 13/00

(52) U.S. Cl. 52/118; 248/304

(57) ABSTRACT

At least one adapter and at least one support bracket are utilized with a boom arm having at least one boom arm section. The at least one adapter is integrally attached by welding to the boom arm section and has a receiving section. The at least one support bracket is received in the receiving section of said at least one adapter. The boom arm has telescoping sections, and an adapter and support bracket is positioned secured at each section. The support bracket receives a cable, to facilitate retention of the cable to the boom arm for use at a platform located at the top of the arm.

### FIELD OF THE INVENTION

The present invention relates to adapters for aerial equipment having extendable arms and cables, and particularly as construction equipment having an aerial work platform such as boom baskets or cherry pickers. More particularly, the present invention relates to adapters welded to the extendable arm of equipment and having a bracket which receives cables running external to the arm.

### DESCRIPTION OF RELATED ART

Aerial work platform assemblies are well known devices for lifting workers or equipment to elevated work areas. In the entertainment or filming industry, boom baskets are commonly used as the aerial work platforms to carry cameramen, cameras, accessories and equipment to elevated work sites. Aerial platforms are shown, for instance, in U.S. Pat. Nos. 7,182,173 and 5,683,063. As shown, the platform includes a boom (or arm) and a work platform (or boom basket). One end of the boom is usually mounted to a vehicle or mobile chassis. The other end of the boom is attached to the work platform. A controller raises the end of the boom that is attached to the work platform to a desired aerial work site.

Often, power and other electronic cables are needed at the work platform, such as to provide power to electrical equipment being used at the work platform. The cables are sometimes tied by rope or a ratchet mechanism along the outer length of the boom. However, the use of rope and ratchet mechanisms is not very secure and can be awkward and inconvenient. In addition, attachments using ropes or the like do not always yield satisfactory results and can be damaging to the boom arm cable track (which is the square tubing that protects the cables). Ropes and ratchet mechanisms are not very secure as a means to attach the cable to the boom. They can become dislodged, which is unsafe to the users or those standing or working beneath the boom and disconnecting from the electrical equipment. In addition, the rope and latching mechanism do not allow the cable to slide freely, and as a result the cable can snag or require the operator to aggressively pull on the cable to extend it to a desired length, or, require the operator to retract the entire boom arm, so that cable can be repositioned which requires significant time.

### SUMMARY OF THE INVENTION

It is therefore an object of this invention to provide an improved aerial work platform that overcomes some of the problems and shortcomings of the prior art. In particular, it is an object to provide a boom which supports cable used for accessories and equipment to be attached securely, easily, and conveniently. Another object of the invention is to provide a boom to which the accessories and equipment can be attached more securely than what the rope and ratchet mechanism can provide, hence enhancing safety for workers or bystanders underneath the boom. Another object of the invention is to provide an improved adapter for receiving and securing cable to a boom.

In accordance with the invention, at least one adapter and at least one support bracket are provided for use with a boom arm having at least one boom arm section. The at least one adapter is integrally attached by welding to the boom arm section and has a receiving section. The at least one support bracket is received in the sleeve of said at least one adapter. The boom arm has telescoping sections, and an adapter and support bracket is positioned secured at each section. The support bracket receives a cable, to facilitate retention of the cable to the boom arm for use at a platform located at the top of the arm.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 shows a perspective view illustrating a boom with cable in accordance with one exemplary embodiment of the present invention;

FIG. 2 is a front view of an adapter and bracket in FIG. 1 in accordance with the present invention; and,

FIG. 3 shows an exploded view of an adapter in accordance with yet another exemplary embodiment of the present invention.

### DETAILED DESCRIPTION OF THE PREFERRED EMBODIMENTS

Preferred embodiments of the invention will be set forth in detail with reference to the drawings, in which like reference numerals refer to like elements or steps throughout.

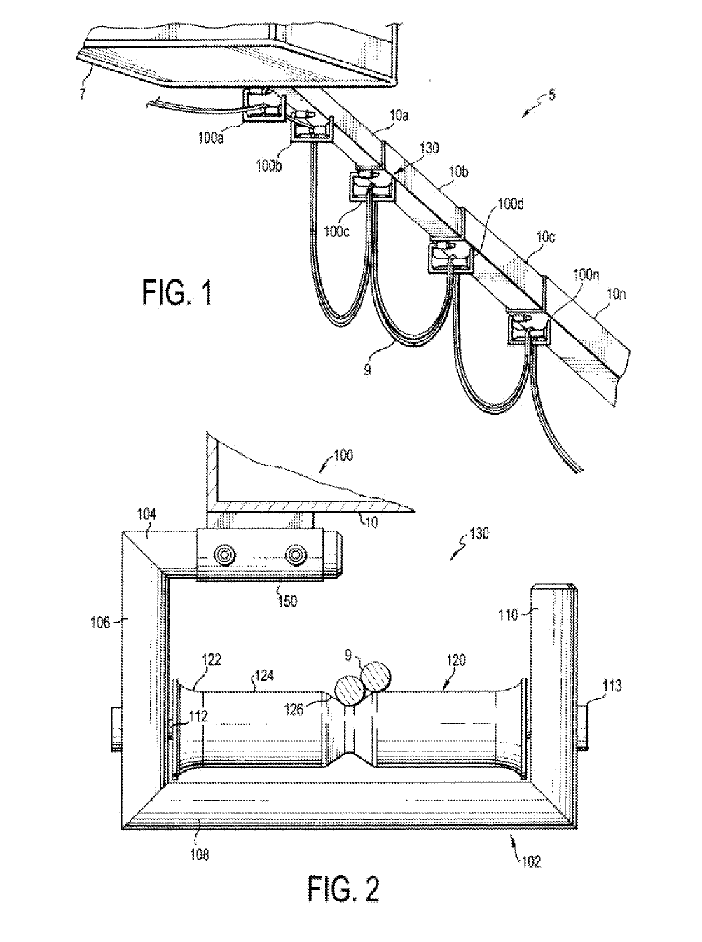

FIG. 1 is a perspective view of a boom assembly 5 in accordance with one exemplary embodiment of the present invention. The assembly 5 includes a boom 10, an aerial work platform generally indicated as 7, and an adapter and bracket assembly 100.

In the preferred embodiment, the boom 10 is an elongated arm which can be extended and retracted. The boom has various telescoping sections 10a . . . 10n, which are slidably received in the neighboring arm sections to extend and retract the arm 10. A boom basket 7 is located at a distal end of the boom 7. The adapter assemblies 100a . . . 100n are integrally and permanently attached to various locations along the boom arm 10. Preferably, an adapter and bracket assembly 100a . . . 100n is positioned at the distal end of each arm section 10a . . . 10n, so that the assemblies 100 can remain fixed to the arm 10 while it is fully retracted without obstructing the arm 10 from retracting. As further shown in FIG. 1, additional assemblies 100a, 100b can optionally be provided closer to the platform 7, though are not necessary.

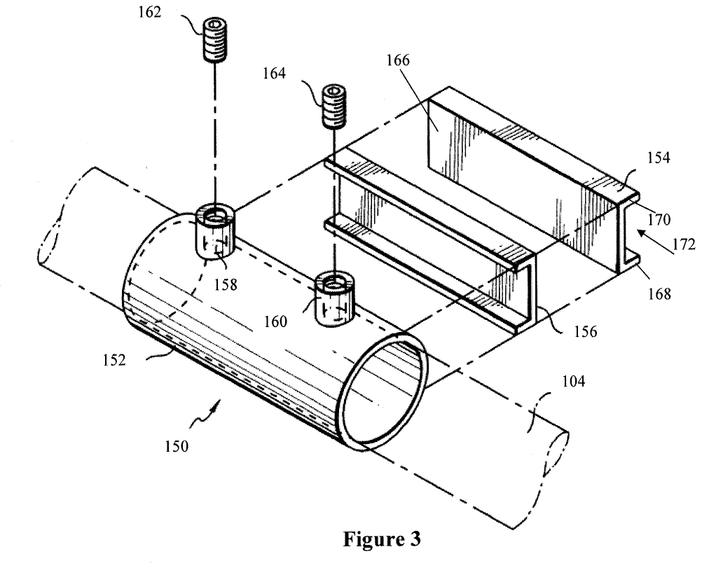

FIG. 2 shows the adapter and bracket assembly 100 in further detail. The assembly 100 generally includes an adapter or receiver 150 and a generally flattened U-shaped support bracket 102. The adapter 150 is integrally attached to the boom 10, preferably by welding, such that the adapter 150 permanently and integrally become parts of the boom 10. FIG. 3 shows the detail of the adapter 150 of FIGS. 1 and 2, which is also described in co-pending application Ser. No. 12/130,314, filed May 30, 2008, the contents of which are hereby incorporated by reference. The present invention can be utilized in conjunction with the invention disclosed in the co-pending application. The adapter 150 includes a tubular receiving section or sleeve 152, a first threaded boss 158, a second threaded boss 160, a first bolt 162, a second bolt 164, a first bracket 154, and a second bracket 156. The first bracket 154 and the second bracket 156 have similar rectangular shapes.

The first and second brackets 154, 156 have a rectangular back 166 and two side walls 168, 170 that extend substantially perpendicular to the back 166 to form a receiving channel 172 therebetween and form a flattened C- or U-shape cross-section. The side walls 168, 170 of the brackets 154, 156 can be formed with the back 166 from a single piece of material. The second bracket 156 is attached to the sleeve 150 by positioning the outside of the sleeve 150 in the channel 172 and welding the ends of the side walls 168, 170 to the sleeve 150 where the side walls 168, 170 mate up against the sleeve 150. The back 166 of the first bracket 154 is attached to the back of the second bracket 156, preferably by welding. Likewise, the side walls 168, 170 of the first bracket 154 are welded to the outside of the boom 10. Referring briefly back to FIGS. 1 and 2, the adapters 150 are attached to the boom arm 10.

The support bracket 102 includes various section members 104, 106, 108 and 110. Two side members 106, 110 are attached to the ends of the bottom member 108. A short top member 104 is attached at the top of one of the side members 106, 110 and extends inwardly. Thus, the support bracket 102 has a general U-shape, but with a short top member 104 which partially closes the support bracket 102.

A center rod 112 extends across the bottom of the support bracket 102. The rod 112 extends through openings in the side members 106, 110. The ends of the rod 112 are threaded and are secured to the side members 106, 110 by a locking nut 113 which is placed over the threaded ends of the rod 112 on the outside of the side members 106, 110. A tubular roller 120 is placed over the rod 112 between the side members 106, 110. The roller 120 receives the cables 9, and rotates over the rod 112 to allow the cables 9 to freely pass between the support brackets 102. The roller 120 is preferably a rubber or other elastomer or plastic material to protect the cables 9 against damage, or alternatively a padding 124 can be placed over the roller 120 to protect the cables 9 against damage. The padded sides 124 can be tapered slightly toward the center of the roller 120, to bias the cables 9 toward the center of the roller 120. The ends 122 of the roller 120 are flared outward so the cables 9 do not get stuck on the ends of the roller 120. A plastic washer can be provided between the roller 120 and the side arms to reduce wear of the roller 120. In addition, the center of the roller 120 has a curved depression 126 which further receives the cables 9.

Once the bracket 156 is welded to the sleeve 152 and the bracket 154 is welded to the boom arm 10, the top member 104 of the support bracket 102 is slidably inserted into the opening in the sleeve 152 and fastened to the sleeve 152 by way of the bolts 162, 164. The bolts 162, 164 are screwed into the threaded bosses 158, 160, respectively, through the sleeve 152 and press the top tube member 104 against the sleeve 152 to fix the tube member 104 into the sleeve 152. Thus, the adapter 150 connects the horizontally-positioned top member 104 of the support bracket 102 to the arm 10. The adapter 150 allows the support bracket to be removed and replaced as necessary by use of the bolts 162, 164. However, it should be appreciated that the support bracket can be directly connected to the boom arm 10 without the use of an adapter 150. The lock nuts 113 are provided at the open end of the adapter to secure the roller from coming free.

Returning to FIG. 1, once the adapter assemblies 100 are attached to the arm 10, the cables 9 can be inserted into the assemblies 100. As shown in FIG. 2, the top member 104 is shorter than the bottom member 108, and the right size member 110 is shorter than the left side member 106. Accordingly, a gap 130 is formed at the corner of the support bracket 102. The bottom member 108 is preferably wider than the width of the boom arm 10, so that the support bracket 100 extends out beyond the boom arm 10. Accordingly, as shown in FIG. 1, the gap 130 provides sufficient clearance between the end of the upright side arm 110 and the boom arm 10 to permit the cable 9 to enter the support bracket 102. However, the gap 130 is not made too large, so that a sufficient number of cables 9 can be retained by the support bracket 102 without coming free of the bracket 102.

As further shown in the embodiment of FIG. 1, the cable 9 can be draped between the various adapter assemblies 100a . . . 100n. The cable 9 is preferably positioned within the assemblies 100 when the boom arm 10 is at least partially extended, so that excess cable 9 can be draped between the assemblies 100. As the boom arm 10 extends and retracts, the cable 9 can freely slide on the rollers 120 without fear of becoming damaged, entangled, or snagged. When the cable 9 is no longer needed, it can be easily removed by lifting the cable 9 out through the gap 130.

In the present invention, the length of the sleeve of each of the adapters is approximately 4.5 inches, the inner diameter of the sleeve's opening is approximately 1¾ inches, and the length of the first and second brackets is approximately 4 inches. The sleeve and brackets of the adapter, however, may be of any desired size. Furthermore, the adapters may be made out of metal, plastic, or any other material that would allow an elongated support member to be inserted inside the sleeve. Furthermore, it is understood that some or all of the parts of the adapters may be molded or formed integrally as one piece. The adapters may also be formed as one integral piece with the support bracket 102.

The support bracket is approximately 15 inches wide (i.e., the outer length of the bottom member 108), 11 inches tall on the closed end (i.e., the outer length of the side member 106), 8⅝ inches tall on the open end (i.e., the outer length of the side member 110), and 6⅜ inches wide on the open end (i.e., the inner length of the top member 104). The gap 130, as measured from the distal end of the side member 110 to the distal end of the top member 104, is approximately 5½ inches. The support bracket 102 is preferably tubular, having an inner diameter of 1¼ inches. The support bracket 102 is preferably made of aluminum to be lightweight and easy to handle, yet sturdy enough to be secured within the adapter 150 and hold the weight of the cable 9. In addition, ridges are formed on the outside of the support bracket 102, to make it easier to handle and grab when inserting into the adapter 150 and during use. Preferably, the ridges (such as cross-hatches) are formed in at least the portion of the top member 104 which is covered by the adapter 150, so that the bolts 162, 164 can better grip the adapter.

Though the invention is described for use with a cherry picker having a telescoping boom arm, it should be recognized that it can be used with any equipment in which cables are needed. For instance, the adapter assembly 100 can be provided with a fixed boom arm, or where there is no boom basket. In addition, though the adapter 100 is preferably created by welding the brackets 154, 156 to each other and the sleeve 152, it should be understood that any well known method of integrally attaching two elements together, including but not limited to forming two plastic elements together as one piece through molding, may be used. And, the bracket 154 can be secured to the boom arm 10 by any suitable process other than welding. In addition, the assemblies 100 can be utilized to carry other equipment or objects, other than cables 9.

The cross section of the support bracket 102 and adapter 150 can be any shape such as round, square, etc. The tubes can also be hollow or solid. The cross section of the sleeve 152 and the top member 104 are preferably round but can be square or another shape. Moreover, the adapters can have sleeves of different sizes so the tube sizes can be different. The brackets 154, 156 can receive tubes of varying dimensions, including larger sleeve 152.

The permanent adapters and support bracket assemblies disclosed herein can be used for any type of elevated work platform, including cherry pickers used by construction, telephone, and cable workers, or apparatus that are built by grip and lighting technicians in the entertainment industry.

While certain exemplary embodiments of the present invention have been shown and described with reference to certain preferred embodiments thereof, it will be understood by those skilled in the art that various changes in form and details may be made therein without departing from the spirit and scope of the invention as defined by the appended claims and their equivalents.

1. A boom arm, comprising:
at least one boom arm section;
at least one adapter integrally attached to the boom arm section, said at least one adapter having a receiving section; and
a support bracket received in the receiving section of said at least one adapter.

2. The boom arm of claim 1, wherein the at least one adapter is integrally attached to said at least one boom arm section by being welded to said at least one boom arm section.

3. The boom arm of claim 1, wherein said support bracket has a U-shape.

4. The boom arm of claim 1, wherein said support bracket has a top member received in the receiving section, a first side member attached to the top member, a bottom member with a first end attached to the first side member and a second end, and a second side member having a first end attached to the second end of the bottom member and a free second end.

5. The boom arm of claim 4, wherein a gap is formed between said second end of said second side member and the second end and the boom arm.

6. The boom arm of claim 1, wherein an elongated roller is mounted within said support bracket.

7. The boom arm of claim 1, wherein said support bracket has two side members, and further comprising an elongated roller mounted to the two side members.

8. The boom arm of claim 1, wherein the at least one adapter further comprises:
a sleeve comprising the receiving section;
a fastener adapted to fasten said support bracket to the sleeve; and
a plurality of protrusions on the sleeve, each protrusion having an opening for receiving one of the plurality of fasteners.

9. The boom arm of claim 1, further comprising a plurality of boom arm sections, a plurality of adapters and a plurality of support brackets, each of said plurality of adapters positioned along one of the plurality of boom arm sections and having one of the plurality of support brackets.

10. The boom arm of claim 9, wherein the boom arm is telescoping.

11. The boom arm of claim 1, wherein the boom arm extends and retracts.

12. A bracket, comprising:
a top member having a first end and a second end;
a first side member attached to the first end of said top member;
a bottom member having a first end attached to the first side member and a second end;
a second side member having a first end attached to the second end of the bottom member and a second end; and,
a roller attached to said first side member and said second side member;
wherein a gap is formed between the second end of said top member and the second end of said second side member.

13. The bracket of claim 12, further comprising an adapter having:
a sleeve for receiving the second end of said top member; and
a fastener for securing said top member to said sleeve.

14. The bracket of claim 12, said bracket capable of receiving a cable.

15. A boom arm, comprising:
at least one boom arm section;
a plurality of support brackets positioned along and attached to said at least one boom arm section and capable of receiving a cable.

16. The boom arm of claim 4, further comprising ridges formed on said top member.

17. The bracket of claim 12, further comprising ridges formed on said top member.
